(19) United States
(12) Patent Application Publication
(10) Pub. No.: US 2025/0342467 A1
(43) Pub. Date: Nov. 6, 2025

(54) METHODS FOR DEPLOYING CONTRACT IN BLOCKCHAIN AND BLOCKCHAIN NODES

(71) Applicant: Ant Blockchain Technology (Shanghai) Co., Ltd., Shanghai (CN)

(72) Inventor: Dayi Yang, Hangzhou (CN)

(73) Assignee: Ant Blockchain Technology (Shanghai) Co., Ltd., Shanghai (CN)

(21) Appl. No.: 19/267,118

(22) Filed: Jul. 11, 2025

Related U.S. Application Data
(63) Continuation of application No. PCT/CN2023/135038, filed on Nov. 29, 2023.

(30) Foreign Application Priority Data
Mar. 31, 2023 (CN) 202310341255.3

(51) Int. Cl. G06Q 20/38; G06Q 50/18

(52) U.S. Cl. CPC G06Q 20/389; G06Q 50/18

(57) ABSTRACT

Methods for deploying a contract in a blockchain and blockchain nodes are provided. In an implementation, a method includes: receiving a first transaction for deploying a first contract, where the first transaction invokes a second contract. An incoming parameter for the second contract includes a code identifier of first code and the value of an immutable variable in the first code, the code identifier and the first code are pre-stored in the blockchain, the first code includes a first function for initialize a contract, and the second contract includes a call to the first function. Before executing the first function based on the call in the second contract, obtaining the first function in the first code based on the code identifier when determining that the second contract is a system contract, and storing state data of the first contract in the blockchain by executing the first function.

### CROSS-REFERENCE TO RELATED APPLICATIONS

This application is a continuation of PCT Application No. PCT/CN2023/135038, filed on Nov. 29, 2023, which claims priority to Chinese Patent Application No. 202310341255.3, filed on Mar. 31, 2023, and each application is hereby incorporated by reference in its entirety.

### TECHNICAL FIELD

Embodiments of this specification pertain to the field of blockchain technologies, and in particular, relate to methods for deploying a contract in a blockchain and blockchain nodes.

### BACKGROUND

A blockchain is a novel application model of computer technologies such as distributed data storage, peer-to-peer transmission, consensus mechanisms, and encryption algorithms. In a blockchain system, data blocks are sequentially connected in a time sequence and combined into a chain data structure, and distributed ledgers that cannot be tampered with or forged are cryptographically ensured. The blockchain has characteristics such as decentralization, tamper-resistance of information, and autonomy, and therefore the blockchain has received increasing attention and applications.

### SUMMARY

This application is intended to provide a solution for deploying a contract in a blockchain, to reduce resources needed for deploying a contract.

A first aspect of this specification provides a method for deploying a contract in a blockchain. The method is performed by a blockchain node, and the method includes: receiving a first transaction for deploying a first contract, where the first transaction calls a second contract, an incoming parameter for the second contract includes a code identifier of first code and the value of an immutable variable in the first code, the code identifier and the first code are associatively pre-stored in the blockchain, the first code includes a first function, the first function includes a fixed name and is used to initialize a contract, and the second contract includes a call to the first function; determining whether the second contract is a system contract before executing the first function based on the call in the second contract; obtaining the first function in the first code based on the code identifier when determining that the second contract is a system contract; and storing state data of the first contract in the blockchain by executing the first function, where the state data of the first contract include the code identifier and the value of the immutable variable.

A second aspect of this specification provides a blockchain node, including: a receiving unit, configured to receive a first transaction for deploying a first contract, where the first transaction calls a second contract, an incoming parameter for the second contract includes a code identifier of first code and the value of an immutable variable in the first code, the code identifier and the first code are associatively pre-stored in the blockchain, the first code includes a first function, the first function includes a fixed name and is used to initialize a contract, and the second contract includes a call to the first function; a determining unit, configured to determine whether the second contract is a system contract before the first function is executed based on the call in the second contract; an acquisition unit, configured to obtain the first function in the first code based on the code identifier when it is determined that the second contract is a system contract; and a storage unit, configured to store state data of the first contract in the blockchain by executing the first function, where the state data of the first contract include the code identifier and the value of the immutable variable.

A third aspect of this specification provides a computer-readable storage medium. The computer-readable storage medium stores a computer program, and when the computer program is executed in a computer, the computer is enabled to perform the method according to the first aspect.

A fourth aspect of this specification provides a blockchain node, including a storage and a processor. The storage stores executable code, and when executing the executable code, the processor implements the method according to the first aspect.

In the solutions provided in the embodiments of this specification, a contract is deployed at two stages. The first stage is a code storage stage. To be specific, initial contract code is first stored in a blockchain, an immutable variable in the initial code is not replaced with a specific variable value, and the initial code includes an initialization function. The second stage is a contract deployment stage, where a transaction for deploying a contract is sent to the blockchain, the transaction calls a system contract, an incoming parameter for the system contract includes an identifier of the initial code and the value of the immutable variable, and the initialization function is called in the system contract. At this stage, a predetermined permission control protocol is used in a blockchain node to determine whether the transaction calls the system contract, and execution of the initialization function is allowed only when the transaction calls the system contract, to deploy a contract in the blockchain, so that state data of the contract include the identifier of the initial code and the value of the immutable variable. With this setting, overheads for deploying a contract by a user are reduced, and storage resources needed for storing the state data of the contract are also reduced. In addition, security of contract deployment is ensured by using permission control logic in the blockchain node.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description are merely some embodiments of this specification, and a person of ordinary skill in the art can still derive other drawings from these accompanying drawings without creative efforts.

FIG. 1 is a schematic diagram illustrating deployment of a smart contract, according to some embodiments;

FIG. 2 is a schematic diagram illustrating calling of a smart contract, according to some embodiments;

FIG. 3 is a schematic diagram illustrating a block storage structure, according to some embodiments;

FIG. 4 is a flowchart illustrating a method for storing initial contract code, according to some embodiments of this specification;

FIG. 5 is a schematic diagram illustrating initial contract code, according to some embodiments of this specification;

FIG. 6 is a flowchart illustrating a method for deploying a contract, according to some embodiments of this specification;

FIG. 7 is a schematic diagram illustrating state storage of a contract, according to some embodiments of this specification;

FIG. 8 is a flowchart illustrating a method for calling a contract, according to some embodiments of this specification; and

FIG. 9 is a structural diagram illustrating a blockchain node, according to some embodiments of this specification.

### DESCRIPTION OF EMBODIMENTS

To make a person skilled in the art better understand the technical solutions in this specification, the following clearly and comprehensively describes the technical solutions in the embodiments of this specification with reference to the accompanying drawings in the embodiments of this specification. Clearly, the described embodiments are merely some but not all of the embodiments of this specification. Based on the embodiments of this specification, all other embodiments obtained by a person of ordinary skill in the art without creative efforts shall fall within the protection scope of this specification.

Blockchains are generally classified into three types: a public blockchain, a private blockchain, and a consortium blockchain. In addition, there are combinations of a plurality of types, such as a combination of the private blockchain and the consortium blockchain, and a combination of the consortium blockchain and the public blockchain. The public blockchain has the highest degree of decentralization. Bitcoin and Ethereum are examples of the public blockchain. Participants that join the public blockchain can read data records in the blockchain, participate in transactions, contend for ledger permission of a new block, etc. In addition, each participant (embodied as a node of the participant in a blockchain) can freely join and exit the network and perform related operations. The private blockchain is an opposite of the public blockchain. Write permission of the network is controlled by an organization or an institution, and data read permission is specified by the organization. In short, the private blockchain can be a weakly centralized system, and has few participating nodes with strict restrictions. This type of blockchain is more suitable for internal use of specific institutions. The consortium blockchain varies from the public blockchain to the private blockchain, and can implement “partial decentralization”. Each node in the consortium blockchain usually has a corresponding entity organization or institution. Participants are authorized to join the network and form a stakeholder alliance, and jointly maintain the operation of the blockchain.

The public blockchain, the private blockchain, and the consortium blockchain can mostly provide the function of a smart contract. The smart contract in the blockchain is a contract whose execution can be triggered by a transaction in a blockchain system. The smart contract can be defined in the form of code.

Ethereum is used as an example. Supporting users in creating and calling some complex logic in the Ethereum network is the biggest challenge of Ethereum to be different from the Bitcoin blockchain technology. Ethereum is a programmable blockchain, and the core of Ethereum is an Ethereum virtual machine (EVM). Each Ethereum node can run the EVM. The EVM is a Turing-complete virtual machine, which means that the EVM can implement various kinds of complex logic. A user publishing and calling the smart contract in Ethereum runs on the EVM. In fact, the virtual machine directly runs virtual machine code (virtual machine bytecode, referred to as “bytecode” below). The smart contract deployed in the blockchain can be in the form of bytecode.

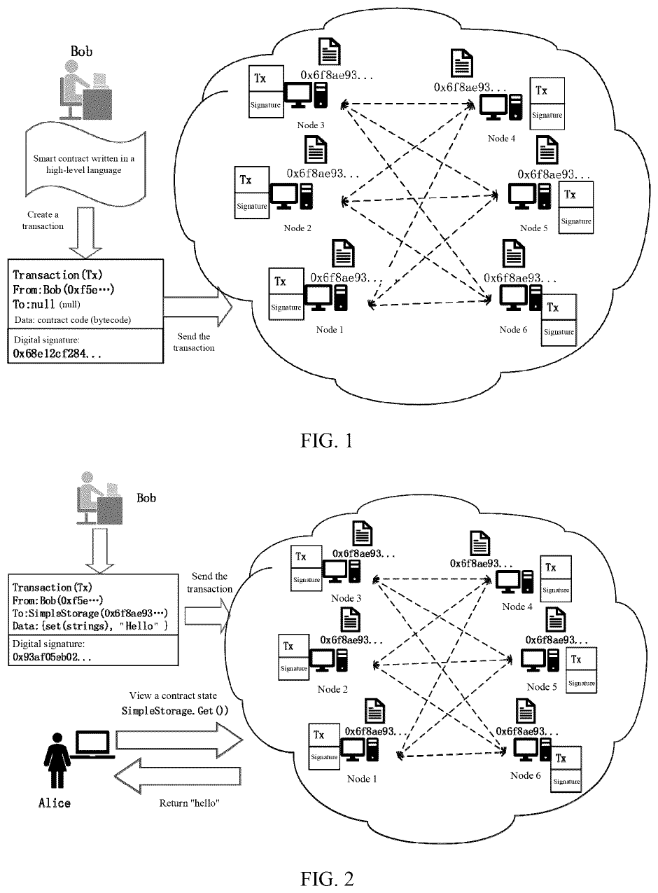

FIG. 1 is a schematic diagram illustrating deployment of a smart contract, according to some embodiments. As shown in FIG. 1, after Bob sends a transaction that includes information for creating a smart contract to an Ethereum network, an EVM of node 1 can execute the transaction and generate a corresponding contract instance. “0x6f8ae93 . . . ” in FIG. 1 represents the address of the contract, a Data field of the transaction can store bytecode, and a To field of the transaction is a null account. After nodes reach an agreement by using a consensus mechanism, the contract is successfully deployed, and users can call the contract subsequently.

After the contract is successfully deployed, a contract account corresponding to the smart contract appears in the blockchain and has a specific address. Contract code and account storage are stored in the contract account. The behavior of the smart contract is controlled by the contract code, while the account storage of the smart contract stores the state of the contract. In other words, the smart contract makes a virtual account including the contract code and the account storage be generated in the blockchain.

As mentioned above, the Data field of the transaction that includes creating a smart contract can include the bytecode of the smart contract. The bytecode consists of a series of bytes. Each byte can identify an operation. Considering the development efficiency, readability, etc., developers can choose a high-level language to write the smart contract code instead of writing bytecode directly. The smart contract code written in the high-level language is compiled by a compiler to generate bytecode, which can be deployed in the blockchain. Ethereum supports many high-level languages, such as Solidity, Serpent, and Lisp-Like Language (LLL).

The Solidity language is used as an example. Contracts written in Solidity are similar to classes in object-oriented programming languages. A plurality of members (or objects) can be stated in a contract, including a state variable, a function, a function modifier, an event, etc. The state variable is a value stored in the account storage of the smart contract, and is used to store the contract state.

The following is code example 1 of a simple smart contract written in the Solidity language:

Code example 1. SimpleStorage code

| | |
|---|---|
| 1 | Contract SimpleStorage { |
| 2 | string storedData; |
| 3 | event stored(address from, string s) |
| 4 | function set(string s) { |
| 5 | storedData = s; |
| 6 | stored(msg.sender, s); |
| 7 | } |
| 8 | function get( ) constant returns (string) { |
| 9 | return storedData; |
| 10 | } |
| 11 | } |

In the above-mentioned code example 1, the second line declares a state variable storedData of a string type, and the third line declares an event. The content stored in the event is the address of an initiator calling the contract and string s. A set function is defined in the fourth to seventh lines. An input parameter is string s. An operation performed by the set function includes setting the input parameter in the state variable storedData to generate an event, where the content of the event includes the address of the initiator calling the contract and string s.

As mentioned above, the state variable is finally stored in a database. The generated event usually takes the following form:

$$[ topic 1 ] [ topic 2 ] … [ topicn ] [ data ]$$

Here, the first topic, namely, topic1, is usually a default value, for example, an identifier of a receipt, and can be a hash value obtained after an event name, an event parameter type, etc. are sequentially concatenated. Whether each of topic2 to topicn exists depends on whether the Indexed modifier is added during definition of a parameter. If yes, the value of the parameter is a topic in the receipt. A parameter that no Indexed modifier is added to is usually placed in data. In the above-mentioned code example 1, when the third line declares the event, the two parameters address from and s are not modified by Indexed, and are usually placed in data. The code in the sixth line sets data content [msg.sender, s] in the stored( ) event by using the event. Therefore, the event operated in the sixth line takes the following general form:
[topic1:event identifier][data: msg.sender, s]

The eighth to tenth lines define a get function. The operation of this function includes returning a queried value of storedData. returns (string) indicates the type of the returned value. The constant modifier indicates that the function cannot modify the value of the state variable in the contract.

In addition, still using Ethereum as an example, as shown in FIG. 2, after Bob sends a transaction that includes information for calling a smart contract to the Ethereum network, the EVM of node 1 can execute the transaction and generate a corresponding contract instance. In FIG. 2, a From field of the transaction is the address of an account that initiates calling of the smart contract, “0x6f8ae93 . . . ” in a To field represents the address of the called smart contract, and a Data field of the transaction stores a method and a parameter for calling the smart contract. After the smart contract is called, the value of storedData may change. Subsequently, a certain client device can view the current value of storedData by using a certain blockchain node (such as node 6 in FIG. 2).

The smart contract can be executed independently by each node in the blockchain network in a specified way, and all execution records and data are stored in the blockchain. Therefore, after the transaction is completed, a transaction certificate that cannot be tampered with or lost is stored in the blockchain.

As mentioned above, storedData in the above-mentioned example is a state variable that is stored in the account storage of the smart contract. In various blockchain networks introducing the smart contract, taking Ethereum as an example, there can usually be two types of accounts: a contract account, which stores executed smart contract code and the value of a state in the smart contract code, and can be activated only through calling by an externally owned account; and the externally owned account, which is an account of a user.

The design of the externally owned account and the contract account is actually a mapping from an account address to an account state. The account state usually includes fields such as Nonce, Balance, Storage root, and CodeHash. Nonce and Balance exist in both the externally owned account and the contract account. The CodeHash and Storage root attributes are usually valid only in the contract account.

Nonce is a counter. For the externally owned account, the number represents the quantity of transactions sent from the account address. For the contract account, the number can be the quantity of contracts created by the account.

Balance is an account balance.

Storage root is a hash value of a root node of an MPT tree. This MPT tree organizes storage of a state variable of the contract account.

CodeHash is a hash value of the smart contract code. For the contract account, CodeHash is a hash value of the smart contract. For the externally owned account, the CodeHash field can usually be an empty string/an all-zero string because no smart contract is included.

MPT is short for Merkle Patricia tree, and is a tree structure that combines a Merkle tree and a Patricia tree (a more space-saving trie). The Merkle tree algorithm calculates a hash value for each transaction, and then hash values are connected in pairs to calculate a hash value again until a Merkle root at the topmost layer is reached. Ethereum uses an improved MPT tree, for example, a 16-ary tree structure, which is also usually referred to as an MPT tree.

A data structure of the MPT tree in Ethereum includes a state trie. The state trie includes a key and value pair (also written as key-value, k-v or kv for short) of storage content corresponding to each account in the Ethereum network. The “key” in the state trie can be an identifier of 160 bits (for example, the address of an Ethereum account or a part of a hash value of the address, collectively referred to as an account address below). The account address is distributed in storage of a root node to a leaf node of the state trie. The “value” in the state trie is generated by encoding information of the Ethereum account (using a recursive-length prefix encoding (RLP) method). As mentioned above, for the externally owned account, the values include Nonce and Balance. For the contract account, the values include Nonce, Balance, CodeHash, and Storage root.

The contract account is used to store a state related to the smart contract. After the smart contract is deployed in the blockchain, a corresponding contract account is generated. This contract account usually has some states that are defined by state variables in the smart contract and that generate new values when the smart contract is executed. The smart contract is a contract that is defined in the form of code in a blockchain environment and whose terms can be automatically executed. Once an event triggers the terms in the contract (an execution condition is satisfied), the code can be automatically executed. In the blockchain, the states related to the contract are stored in a storage trie, and a hash value of a root node of the storage trie is stored in the above-mentioned Storage root, thereby locking all the states of the contract to the contract account through hashing. The storage trie is also an MPT tree structure, and stores a key-value mapping from a state address to a state value. A part of information from the root node to a leaf node of the storage trie is sequentially arranged to store the address of a state, and the value of the state is stored in the leaf node.

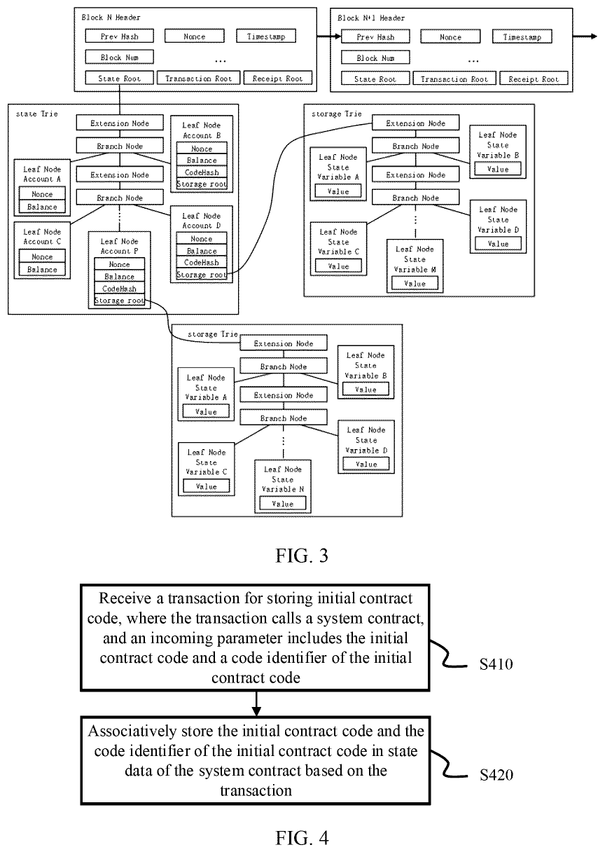

FIG. 3 is a schematic structural diagram illustrating blockchain data storage. As shown in FIG. 3, a block header of each block includes several fields, for example, a previous block hash value previous_Hash (Prev Hash in the figure), a random number Nonce, a timestamp Timestamp, a block number Block Num, a state root hash value State_Root, a transaction root hash value Transaction_Root, and a receipt root hash value Receipt_Root. Prev Hash in a block header of a next block (for example, block N+1) points to a current block (for example, block N), that is, a hash value of the current block. As such, locking of the next block to the current block is implemented in the blockchain by using the block header. State_Root, Transaction_Root, and Receipt_Root respectively lock a state set, a transaction set, and a receipt set. States, transactions, and receipts are respectively organized in the state set, the transaction set, and the receipt set in the form of trees. Generally, the trees can be of the same tree structure, or can be of different tree structures. For example, the same MPT structure is used in Ethereum. In some tree structures including a state set of a smart contract, such as Ethereum, there are two-level MPT structures. An upper-level MPT structure includes two types of leaf nodes: an externally owned account and a contract account. Each contract account includes a next-level MPT structure, and a next-level leaf node includes the value of a state in the contract account.

Ethereum is still used as an example. References can be made to FIG. 3. state_root is a hash value of a root of an MPT tree formed by states of all accounts in a current block, that is, state_root points to a state trie in the form of an MPT. A root node of the MPT tree is usually an extension node or a branch node, and state_root usually stores a hash value of the root node. The root node can be connected to extension nodes/branch nodes in one or more layers below, and these multi-layer tree nodes can be collectively referred to as internal nodes. Some of values from the root node to each of leaf nodes of the MPT are sequentially connected in series to form an account address as a key, and account information stored in the leaf node is a value corresponding to the account address. As such, a key-value pair is formed. The key can alternatively be a part obtained after sha3(Address) is applied, that is, a part of a hash value of an account address (where for example, the sha3 algorithm is used as a hash algorithm). A value stored in the key can be rlp(Account), that is, RLP encoding is performed on account information. The account information is a 4-tuple composed of [nonce, balance, storageRoot, codeHash]. As mentioned above, for the externally owned account, there are usually only two items: nonce and balance. The storageRoot and codeHash fields store empty or all-zero strings by default. That is, the externally owned account does not store a contract or a state variable generated after the contract is executed. The contract account usually includes Nonce, Balance, Storage root, and CodeHash. Nonce is a transaction counter of the contract account. Balance is an account balance. Storage root corresponds to another MPT, and a link to information about a state related to the contract can be achieved by using Storage root. CodeHash is a hash value of contract code. Account information of both the externally owned account and the contract account is usually located in a separate leaf node. There may be several branch nodes and extension nodes from an extension node/a branch node of a root node to a leaf node of each account.

The state trie can be a tree in the form of an MPT, usually a 16-ary tree, that is, each layer can have a maximum of 16 child nodes. The extension node is used to store a common prefix. The extension node usually has one child node, and the child node can be a branch node. The branch node can have a maximum of 16 child nodes, which can include an extension node and/or a leaf node.

For a contract account in the state trie, storage_Root thereof points to another tree also in the form of an MPT, where data of a state variable involved in contract execution are stored. The tree in the form of an MPT that the storage_Root points to is a storage trie, that is, a hash value of a root node of the storage trie. Generally, the storage trie also stores a key-value pair. The key indicates the address of a state variable, and the value thereof can be a result obtained after a location (a value counted from 0) declared by the state variable in the contract is processed by using a certain rule, for example, sha3(the location declared by the state variable) or sha3(a contract name+the location declared by the state variable). The value is used to store the value of the state variable (for example, a value obtained after RLP encoding). Some data stored on a path from a root node to a leaf node passing through an internal node are connected to form the key, and the value is stored in the leaf node. As mentioned above, this Storage trie can also be a tree in the form of an MPT, and is usually also a 16-ary tree. That is, the branch node can have a maximum of 16 child nodes, and the child nodes can include an extension node and/or a leaf node. The extension node can usually have one child node, and the child node can be a branch node or a leaf node.

For example, leaf node account P in the state trie in FIG. 3 is a contract account, and Storage Root thereof locks all states in storage of the contract. These states are organized as an MPT tree having a tree structure the same as a storage trie that Storage Root is linked to. In the linked storage trie, taking leaf node state variable N is used as an example. For example, if leaf node state variable N is the value of storedData in the above-mentioned contract code example, a key thereof can be and is not limited to sha3(a location declared by storedData), and a value thereof is s (for brevity, an encoding format of the value is omitted here, for example, RLP, where the case is similar in the subsequent descriptions, and is omitted for simplicity). The value of the key is sequentially distributed in a root node to a leaf node (that is, leaf node variable N) of the storage trie.

As mentioned above, after a transaction for creating a smart contract is sent to the blockchain, each node in the blockchain can execute the transaction after a consensus on the transaction is reached in the blockchain. At this time, a contract account corresponding to the smart contract appears on the blockchain (including, for example, an identity, Identity, of the account, a hash value, Codehash, of the contract, and a root, StorageRoot, of the contract storage), and has a specific address. Contract code and account storage can be stored in storage of the contract account. The behavior of the smart contract is controlled by the contract code, while the account storage of the smart contract stores the state of the contract. In other words, the smart contract makes a virtual account including the contract code and the account storage be generated in the blockchain. For a contract deployment transaction or a contract update transaction, the value of Codehash will be generated or changed. Subsequently, the blockchain node can receive a transaction request calling the deployed smart contract, and the transaction request can include the address of the called contract, a function in the called contract, and an input parameter. Generally, after consensus on the transaction request is reached, each node in the blockchain can independently execute the smart contract that is designated to be called.

In the deployed contract, the root StorageRoot of the contract storage can be a default value or a hash value calculated based on a root node of a lower-layer storage trie. This usually depends on whether an initialization operation is performed in the deployed contract. For example, the initialization operation is executing an initialization function in the contract. If the deployed contract includes the initialization function, some state variables that are finally stored in an underlying database can usually be initialized. The initialization can be performed in a virtual machine. As mentioned above, the initialized state variables can form an MPT tree, so that a root node of the MPT tree can be obtained, and further, a hash value of the root node can be obtained. If the deployed contract does not include the initialization function, no specific function can be executed, but a default value such as a hash value of empty content is assigned to StorageRoot by a blockchain platform.

After the contract is deployed, as mentioned above, the contract can be subsequently called. As shown in FIG. 2, after Bob initiates a transaction calling a smart contract to an Ethereum network, the contract is executed to set a state variable as a string “hello”. For example, after a transaction calling a contract in FIG. 2 is sent to a blockchain network and consensus is reached, each node can execute the transaction. A To field of the transaction indicates the address of the called contract. Any node can find storage of the contract account based on the address of the contract, and then can read Codehash from the storage of the contract account, so as to find corresponding contract bytecode based on Codehash. The node can load the contract bytecode from the storage to the virtual machine to execute the contract.

Ethereum also supports the inclusion of an immutable variable in the contract. The value of the immutable variable in the contract is set at the time of contract deployment and cannot be changed after contract deployment is completed. When the virtual machine executes a transaction for deploying a contract, the value of an immutable variable in contract code can be determined by using an instruction in an initialization function. For example, the instruction indicates an incoming parameter of the initialization function, so that the virtual machine can determine the value of the immutable variable as the incoming parameter. Specifically, when executing the transaction for deploying a contract, the virtual machine replaces an immutable variable in other function code in the contract with the value (for example, the incoming parameter) indicated in the initialization function by executing the initialization function in the contract code, and stores the updated other function code in the blockchain as the contract code. This means that if two contracts use the same bytecode before deployment, but different values of immutable variables are set, contract code of the two contracts that is deployed in the blockchain is different.

For a contract including an immutable variable, the contract is deployed at two stages in the embodiments of this specification. The first stage is a code storage stage. To be specific, initial contract code is first stored in a blockchain, and an immutable variable in the initial code is not replaced with a specific variable value. The second stage is a contract deployment stage, that is, a transaction for deploying a contract is sent to the blockchain, where the transaction includes an identifier of the initial code and the value of the immutable variable, so that the contract is deployed in the blockchain by executing the transaction, and state data of the contract include the identifier of the initial code and the value of the immutable variable. With this setting, overheads for deploying a contract by a user are reduced, and storage resources needed for storing the state data of the contract are also reduced.

FIG. 4 is a flowchart illustrating a method for storing initial contract code, according to some embodiments of this specification. The method can be performed by any blockchain node.

As shown in FIG. 4, in step S410, the blockchain node receives transaction Tx1 for storing initial contract code, where transaction Tx1 calls a system contract, and an incoming parameter for the system contract includes the initial contract code and a code identifier of the initial contract code.

To deploy a contract, a contract deployer can first execute the above-mentioned first stage, that is, send transaction Tx1 for storing initial contract code to a blockchain, so that each node in the blockchain can receive transaction Tx1. In another case, the first stage can be executed by an initial code publisher to send transaction Tx1 to the blockchain. After sending transaction Tx1 to the blockchain and storing the initial code in the blockchain, the initial code publisher can publish the initial code and the code identifier of the initial code on a specific publishing platform, so that the contract deployer can identify the contract to be deployed based on the code and a need of the contract deployer.

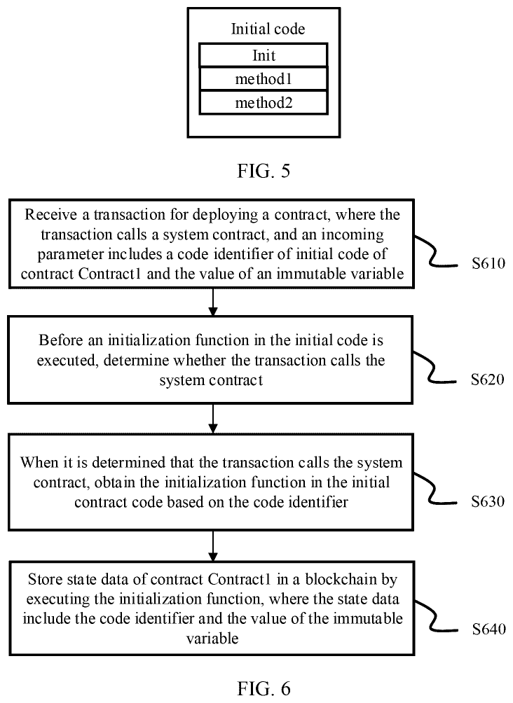

As mentioned above, the initial contract code includes an identifier of an immutable variable without replacing the immutable variable with a specific variable value. Specifically, FIG. 5 is a schematic diagram illustrating initial contract code, according to some embodiments of this specification. As shown in FIG. 5, the initial contract code includes, for example, initialization function Init (that is, code of function Init), function method1, and function method2. Each of function method1 and/or function method2 includes identifiers of one or more immutable variables, for example, immutable variable immut1.

A system contract is pre-deployed in the blockchain, and the system contract can be used to store the initial contract code, deploy a contract, etc. In some implementations, the system contract can be deployed in a genesis block. Transaction Tx1 can call function Storage( ) for storing initial contract code in the system contract, and use the initial contract code and an identifier thereof as incoming parameters of the function. In some implementations, the identifier of the initial contract code can be a code hash value of the initial contract code. In some other implementations, the identifier of the initial contract code can be an easily recognizable string, for example, “code1”. By setting the identifier of the initial contract code in this way, two pieces of initial contract code that have different identifiers and mean the same code can be stored in the blockchain, for example, two pieces of same initial code that respectively use “code1” and “code2” as identifiers are stored, so that the two pieces of initial code can be conveniently updated or upgraded in different ways.

Specifically, in some implementations, transaction Tx1 takes the following form:

{Transaction Tx1
From:Alice(0xf53...)
To:SystemContract
Data:{storage( );code1,“code1”}
}

Assume that SystemContract represents the contract address of the system contract, storage( ) is a function for storing initial contract code in the system contract, code1 is initial code of contract contract1, and “code1” is a code identifier of code1.

In step S420, the blockchain node associatively stores the initial contract code and the code identifier of the initial contract code in state data of the system contract based on transaction Tx1.

After consensus on transaction Tx1 is reached in the blockchain, each node in the blockchain executes transaction Tx1. After completing execution of transaction Tx1, the blockchain node associatively stores the initial contract code and the code identifier of the initial contract code in the state data of the system contract based on the result of executing transaction Tx1.

The initial contract code and the code identifier of the initial contract code are associatively stored, so that the initial contract code stored associatively with the code identifier can be read in the blockchain based on the code identifier.

Specifically, transaction Tx1 includes the code identifier “code i”. After completing execution of transaction Tx1, the blockchain node associatively stores code code1 with the code identifier “code1” in a contract state of the system contract.

After completing the first stage, the contract deployer can deploy the contract by using the second stage.

FIG. 6 is a flowchart illustrating a method for deploying a contract, according to some embodiments of this specification. The method can be performed by any blockchain node in a blockchain.

Referring to FIG. 6, in step S610, the blockchain node receives transaction Tx2 for deploying a contract, where transaction Tx2 calls a system contract, an incoming parameter for the system contract includes a code identifier of initial code of contract Contract1 and the value of an immutable variable in the initial code, and the system contract includes a call to an initialization function.

As mentioned above, in the embodiments of this specification, a contract is deployed at two stages. Therefore, during contract deployment, initial contract code has been stored in the blockchain, and a contract deployer can deploy the contract only by obtaining a code identifier of the initial code corresponding to the contract to be deployed, without a need to include the contract code in a transaction for deploying a contract.

For example, transaction Tx2 takes the following form:

{Transaction Tx2
From:Bob(0xf53...)
To: SystemContract
Data:{ deploy( );“code1”;immut1=V1}
}

deploy( ) is a function for deploying a contract in the system contract, “code1” is the code identifier of initial contract code code1 corresponding to the contract to be deployed, immut1 is an identifier of the immutable variable in initial code code1, and V1 is the value of immutable variable immut1. In some implementations, an incoming parameter of function deploy( ) in transaction Tx2 further includes the contract address of the contract to be deployed, and the contract address is generated by the contract deployer and placed in transaction Tx2 as the incoming parameter. Function deploy( ) includes the call to the initialization function. In the embodiments of this specification, the name of the initialization function in initial code of each contract is set to a fixed name, for example, Init( ). Therefore, by including the call to function Init( ) in function deploy( ), when a user calls function deploy( ) to deploy any contract, function Init( ) in the specific initial code can be called based on the code identifier of the initial code in the incoming parameter.

That is, unlike the transaction for deploying a contract shown in FIG. 1, transaction Tx2 does not include contract code, but includes the code identifier “code1” of the initial contract code and value V1 of immutable variable immut1 in the initial code. As such, the data amount of transaction Tx2 is greatly reduced compared with the data amount of the transaction in FIG. 1, so that communication bandwidth resources occupied in the blockchain to broadcast transaction Tx2, computing resources consumed by the blockchain node to verify a transaction signature, etc. can be reduced. In addition, from the perspective of the user, the contract deployer usually needs to consume resources in the blockchain (for example, gas in Ethereum) to send a transaction to the blockchain, and the amount of gas consumed is positively correlated with the amount of sent transaction data. Overheads of the user in the blockchain are greatly reduced by reducing the amount of transaction data.

It can be understood that the above-mentioned form of transaction Tx2 is merely an example, and the transaction for deploying a contract in the embodiments of the specification is not limited thereto. For example, in a case, function Init in the initial contract code can set the value of the immutable variable to be equal to the value of a transaction sender (that is, a From field), so that no value needs to be additionally assigned to the immutable variable in the transaction for deploying a contract.

In step S620, before the initialization function in the initial code is executed based on the call to the initialization function in the system contract, it is determined whether transaction Tx2 calls the system contract.

After consensus on transaction Tx2 is reached in the blockchain, the blockchain node can execute transaction Tx2. Specifically, the blockchain node obtains code of the system contract by calling function deploy in the system contract based on transaction Tx2, and obtains function deploy from the code of the system contract, to start to execute function deploy. When the blockchain node executes the call to initialization function Init in the process of executing function deploy, before executing function Init based on the call, the blockchain node first determines, based on platform code of a blockchain platform, whether transaction Tx2 calls the system contract. The platform code represents the platform protocol of the blockchain platform. Specifically, the blockchain node reads a contract address in a To field in transaction Tx2 to determine whether the contract address is consistent with a predetermined contract address of the system contract. If the contract address is consistent with the predetermined contract address, the blockchain node can determine that transaction Tx2 calls the system contract. If the contract address is inconsistent with the predetermined contract address, the blockchain node can determine that transaction Tx2 does not call the system contract.

In the case of consistency, the blockchain node performs step S630 in FIG. 6. That is, each time the blockchain node reads the call to function Init in the process of executing the transaction, before executing function Init, the blockchain node first determines whether the transaction calls the system contract. If the transaction does not call the system contract, the blockchain node ends execution of the transaction, and determines that the transaction fails to be executed. Therefore, the blockchain node performs permission control on contract deployment by using the determining process, to ensure that only the system contract calls function Init to deploy a contract. By ensuring that only the system contract is allowed to call function Init, another contract can be prevented from resetting state data of a deployed contract by calling function Init, so that security of contract deployment is improved.

When transaction Tx2 includes the contract address generated by the deployer of contract Contract1, code can be predetermined in the system contract to determine whether the contract address has been deployed. Specifically, the blockchain node determines, based on the predetermined code, whether a state database includes state data corresponding to the contract address. If the state database includes the state data corresponding to the contract address, it indicates that the contract address has been deployed, and the blockchain node ends execution of the transaction, and determines that the transaction fails to be executed. If it is determined that the state database does not include the state data corresponding to the contract address, it indicates that the contract address is not deployed, and the blockchain node continues to perform the subsequent step S630. By using the predetermined code in the system contract, it can be ensured that function Init is called only during contract initialization (that is, the contract address is not deployed in the blockchain), that is, it can be ensured that the initialization function of the contract is called only once in a life cycle of the contract, so that the state data of the deployed contract are prevented from being reset, thereby improving security of contract deployment.

In step S630, when determining that transaction Tx2 calls the system contract, the blockchain node obtains initialization function Init( ) in the initial code of contract Contract1 based on the code identifier in transaction Tx2.

When the blockchain node determines that transaction Tx2 calls the system contract, or when the blockchain node determines that transaction Tx2 calls the system contract and the contract address in the transaction Tx2 is not deployed, the blockchain node can read, from a contract state of the system contract, the initial code corresponding to the code identifier “code1” based on the code identifier in transaction Tx2, and read initialization function Init( ) from the initial code.

In step S640, after reading the initialization function, the blockchain node stores state data of contract Contract1 in the blockchain by executing the initialization function, where the state data include the code identifier and the value of the immutable variable.

When the incoming parameter of function deploy in transaction Tx2 does not include the contract address, the blockchain node executes initialization function Init to generate the contract address corresponding to contract Contract1, adds a leaf node corresponding to the contract address to the above-mentioned state trie based on the contract address corresponding to contract Contract1, and stores the state data (or state storage) of contract Contract1 in the leaf node.

When the incoming parameter of function deploy in transaction Tx2 includes the contract address, the blockchain node executes initialization function Init, adds a leaf node corresponding to the contract address to the above-mentioned state trie based on the contract address corresponding to contract Contract1, and stores the state data of contract Contract1 in the leaf node. Specifically, a write interface provided by the blockchain platform can be called in function Init, and each field of the state data is written into the leaf node corresponding to contract Contract1.

FIG. 7 is a schematic diagram illustrating state storage of a contract, according to some embodiments of this specification. As shown in FIG. 7, the state storage of contract Contract1 generated based on transaction Tx2 can include the following fields: Nonce, balance, Storage hash, Ref, and Immut. The Nonce, balance, and Storage hash fields are the same as the same fields in the state storage of the contract shown in FIG. 3. Details are omitted here for simplicity. Unlike the state storage of the contract in FIG. 3, the state storage of contract Contract1 further includes an Ref field and an Immut field, where the Ref field is an identifier (for example, “code1”) of contract code referenced by contract Contract1, and the Immut field includes the value (for example, V1) of an immutable variable (for example, Immut1) in contract Contract1. In addition, the state storage of contract Contract1 does not include a code hash field, that is, the contract code is not additionally stored in the deployed contract Contract1, and therefore, a hash value of the code does not need to be included in the state storage of contract Contract1.

As shown in FIG. 7, a contract deployer can also deploy contract Contract2 and contract Contract3 that reference code1 in a blockchain in the same way. That is, Ref fields in contract Contract2 and contract Contract3 are code1, which indicates that contract Contract1 to contract Contract3 reference the same initial contract code, but the values of immutable variables in contract Contract1 to contract Contract3 are different from each other. It can be seen from FIG. 7 that in the methods in the embodiments of this specification, to deploy a plurality of contracts that reference the same initial contract code, only one piece of initial contract code needs to be stored, and a plurality of pieces of final code (the final code is code obtained by replacing an immutable variable in the initial code with a variable value) corresponding to the initial code do not need to be stored, thereby reducing the amount of data that need to be stored and reducing storage resources.

It can be understood that the state storage of the contract shown in FIG. 7 is applicable to a contract in which the value of an immutable variable needs to be set, and a contract in which the value of an immutable variable does not need to be set can continue to use the state storage shown in FIG. 3.

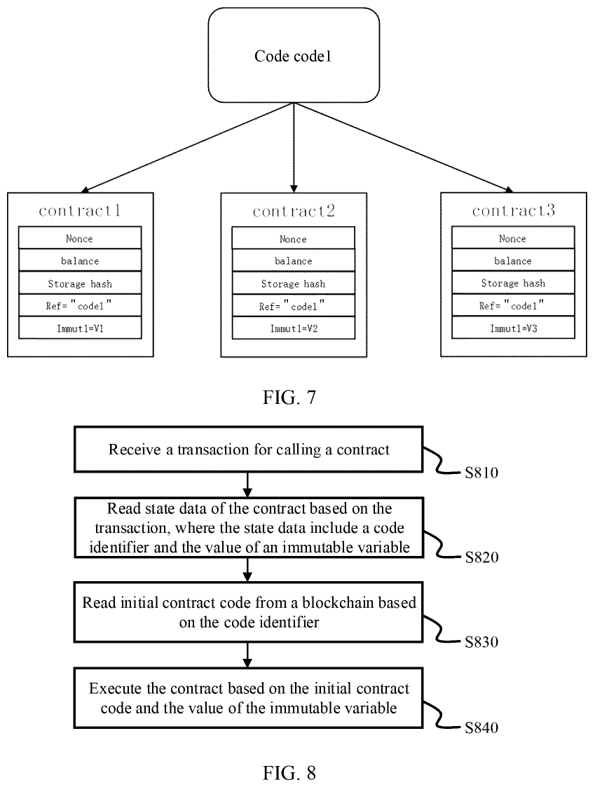

FIG. 8 is a flowchart illustrating a method for calling a contract, according to some embodiments of this specification. The method is applicable to a contract with the state storage shown in FIG. 7, and the following provides descriptions by using contract Contract1 as an example.

As shown in FIG. 8, in step S810, a transaction for calling a contract is received.

When a blockchain user (for example, Bob) expects to call contract Contract1, transaction Tx3 for calling contract Contract1 can be sent to a blockchain. For example, transaction Tx3 takes the following form:

{Transaction Tx3
From:Bob(0xf53...)
To:Contract1
Data:{method1;arg}}

Transaction Tx3 calls function method1 in contract Contract1. Similar to the transaction for calling a contract shown in FIG. 2, a From field of transaction Tx3 is Bob, a To field is a contract address of contract Contract1, and a Data field is the function name of function method1 and an incoming parameter (arg) of function method1.

After the user Bob sends transaction Tx3 to the blockchain, transaction Tx3 is broadcast in the blockchain, so that each blockchain node can receive transaction Tx3 to execute transaction Tx3.

In step S820, the blockchain node reads state data of contract Contract1 based on the transaction, where the state data include a code identifier and the value of an immutable variable as mentioned above.

When executing transaction Tx3, the blockchain node reads the state data of contract Contract1 from a state database of the blockchain, that is, the state storage of contract Contract1 shown in FIG. 7, based on the contract address of contract Contract1 in transaction Tx3. As shown in FIG. 7, the state storage of contract Contract1 includes the code identifier “Ref=code1” and the value “Immut1=V1” of the immutable variable.

In step S830, the blockchain node reads initial contract code from the blockchain based on the code identifier.

After obtaining the code identifier “code1” of contract Contract1, the blockchain node can read initial contract code corresponding to “code1” from the blockchain based on the code identifier. The initial contract code is, for example, stored in a contract state of a system contract, and the blockchain node can read the contract state of the system contract based on a predetermined contract address of the system contract, and read code stored associatively with the code identifier “code1” from the contract state. The code is the initial contract code of contract Contract1.

In step S840, contract Contract1 is executed based on the initial contract code of contract Contract1 and the value of the immutable variable.

After obtaining the initial code of contract Contract1, the blockchain node replaces the immutable variable in the initial code with the value of an immutable variable in the state storage of contract Contract1, to obtain final code of contract Contract1, and the blockchain node can execute contract Contract1 based on the final code.

Specifically, based on the call to function method1 in transaction Tx3, the blockchain node can obtain initial code of function method1 in the initial code, and replace an immutable variable (for example, Immut1) in the initial code of function method1 with value V1 of Immut1 in the state storage to obtain final code of function method1. Then the blockchain node can pass the incoming parameter in transaction Tx3 to execute the final node of function method1, thereby completing execution of transaction Tx3.

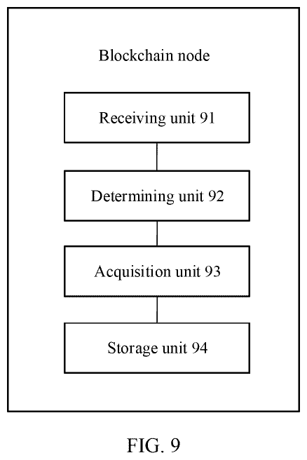

FIG. 9 is a structural diagram illustrating a blockchain node, according to some embodiments of this specification. The blockchain node includes: a receiving unit 91, configured to receive a first transaction for deploying a first contract, where the first transaction calls a second contract, an incoming parameter for the second contract includes a code identifier of first code and the value of an immutable variable in the first code, the code identifier and the first code are associatively pre-stored in the blockchain, the first code includes a first function, the first function includes a fixed name and is used to initialize a contract, and the second contract includes a call to the first function; a determining unit 92, configured to determine whether the second contract is a system contract before the first function is executed based on the call in the second contract; an acquisition unit 93, configured to obtain the first function in the first code based on the code identifier when it is determined that the second contract is a system contract; and a storage unit 94, configured to store state data of the first contract in the blockchain by executing the first function, where the state data of the first contract include the code identifier and the value of the immutable variable.

Some embodiments of this specification further provide a computer-readable storage medium. The computer-readable storage medium stores a computer program, and when the computer program is executed in a computer, the computer is enabled to perform the method shown in FIG. 4, FIG. 6, or FIG. 8.

Some embodiments of this specification further provide a blockchain node, including a storage and a processor. The storage stores executable code, and when executing the executable code, the processor implements the method shown in FIG. 4, FIG. 6, or FIG. 8.

In the solutions provided in the embodiments of this specification, a contract is deployed at two stages. The first stage is a code storage stage. To be specific, initial contract code is first stored in a blockchain, an immutable variable in the initial code is not replaced with a specific variable value, and the initial code includes an initialization function. The second stage is a contract deployment stage, where a transaction for deploying a contract is sent to the blockchain, the transaction calls a system contract, an incoming parameter for the system contract includes an identifier of the initial code and the value of the immutable variable, and the initialization function is called in the system contract. As such, a contract is deployed in the blockchain by executing the initialization function, so that state data of the contract include the identifier of the initial code and the value of the immutable variable. With this setting, overheads for deploying a contract by a user are reduced, and storage resources needed for storing the state data of the contract are also reduced. In addition, security of contract deployment is ensured by using permission control logic in the blockchain node.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written into a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicon Labs C8051F320. The storage controller can also be implemented as a part of the control logic of the storage. A person skilled in the art also knows that in addition to implementing the controller by using only the computer-readable program code, logic programming can be performed on method steps to enable the controller to implement the same function in the form of a logic gate, a switch, an application-specific integrated circuit, a programmable logic controller, an embedded microcontroller, etc. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The system, apparatus, module, or unit illustrated in the above-mentioned embodiments can be implemented by using a computer chip or an entity, or can be implemented by using a product having a certain function. A typical implementation device is a server system. Certainly, this application does not exclude that with development of future computer technologies, a computer that implements a function of the above-mentioned embodiment can be, for example, a personal computer, a laptop computer, a vehicle-mounted man-machine interaction device, a cellular phone, a camera phone, a smartphone, a personal digital assistant, a media player, a navigation device, an e-mail device, a game console, a tablet computer, a wearable device, or a combination of any of these devices. Although one or more embodiments of this specification provide method operating steps as described in the embodiments or a flowchart, more or fewer operating steps may be included on the basis of conventional or noncreative means. A sequence of steps listed in the embodiments is merely one of various step execution sequences and does not indicate a sole execution sequence. In practice, when being executed by an apparatus or an end-user device product, the steps can be performed sequentially or in parallel (for example, by parallel processors or in a multi-thread processing environment, or even in a distributed data processing environment) based on the method shown in the embodiments or the accompanying drawings. The terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, the existence of additional identical or equivalent elements in the process, method, product, or device that includes the elements is not excluded. For example, if the words first, second, etc. are used for indicating names, they do not indicate any particular order.

For the convenience of description, the above-mentioned apparatuses are divided into various modules according to functions for respective descriptions. Certainly, during implementation of one or more embodiments of this specification, the functions of the modules can be implemented in same one or more pieces of software and/or hardware, or modules implementing the same function can be implemented by using a combination of a plurality of sub-modules or sub-units, etc. The described apparatus embodiments are merely examples. For example, division into the units is merely logical function division and there can be other division manners in actual implementation. For example, a plurality of units or components can be combined or integrated into another system, or some features can be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

This application is described with reference to a flowchart and/or a block diagram of a method, an apparatus (system), and a computer program product according to some embodiments of this application. It should be understood that each procedure and/or block in the flowcharts and/or the block diagrams and a combination of procedures and/or blocks in the flowcharts and/or the block diagrams can be implemented by using computer program instructions. These computer program instructions can be provided for a general-purpose computer, a special-purpose computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions can be stored in a computer-readable storage that can instruct the computer or the another programmable data processing device to work in a specific way, so the instructions stored in the computer-readable storage generate an artifact that includes an instruction apparatus. The instruction apparatus implements a specific function in one or more procedures in the flowcharts and/or in one or more blocks in the block diagrams. These computer program instructions can be loaded onto the computer or the another programmable data processing device, so that a series of operation steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more central processing units (CPU), input/output interfaces, network interfaces, and memories. The memory may include a non-persistent storage, a random access memory (RAM), a non-volatile memory, and/or another form in a computer-readable medium, for example, a read-only memory (ROM) or a flash memory (flash RAM). The memory is an example of the computer-readable medium. The computer-readable medium includes persistent, non-persistent, removable and non-removable media that can store information by using any method or technology. The information can be a computer-readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in this specification, the computer-readable medium does not include transitory media such as a modulated data signal and carrier.

A person skilled in the art should understand that one or more embodiments of this specification can be provided as a method, a system, or a computer program product. Therefore, one or more embodiments of this specification can take the form of a complete hardware embodiment, a complete software embodiment, or an embodiment incorporating a software and hardware aspect. In addition, the one or more embodiments of this specification can use a form of a computer program product that is implemented on one or more computer-usable storage media (including but not limited to a disk storage, a CD-ROM, an optical storage, etc.) that include computer-usable program code.

The one or more embodiments of this specification can be described in the general context of computer-executable instructions executed by a computer, for example, a program module. Generally, the program module includes routines, programs, objects, assemblies, data structures, etc. that perform specific tasks or implement specific abstract data types. The one or more embodiments of this specification can also be practiced in a distributed computing environment where tasks are performed by remote processing devices that are connected through a communication network. In the distributed computing environment, the program module can be located in both local and remote computer storage media including storage devices.

The embodiments of this specification are described in a progressive way. For the same or similar parts of the embodiments, mutual references can be made to the embodiments. Each embodiment focuses on a difference from other embodiments. Particularly, the system embodiments are basically similar to the method embodiments, and therefore are described briefly. For related parts, references can be made to some descriptions in the method embodiments. In the descriptions of this specification, descriptions of reference to terms such as “an embodiment”, “some embodiments”, “an example”, “a specific example”, or “some examples” mean that specific features, structures, materials, or characteristics described with reference to the embodiment or example are included in at least one embodiment or example of this specification. In this specification, illustrative expressions of the above-mentioned terms are not necessarily intended for the same embodiment or example. Moreover, the specific features, structures, materials, or characteristics described can be combined in any one or more embodiments or examples in a suitable manner. In addition, a person skilled in the art can combine and associate different embodiments or examples and features of different embodiments or examples described in this specification, provided that the embodiments or examples and the features do not conflict with each other.

The above-mentioned descriptions are merely embodiments of the one or more embodiments of this specification, and are not intended to limit the one or more embodiments of this specification. A person skilled in the art knows that one or more embodiments of this specification can have various modifications and changes. Any modifications, equivalent replacements, improvements, etc. made without departing from the spirit and principle of this specification shall fall within the scope of the claims.

1. A method for deploying a contract in a blockchain performed by a blockchain node, wherein the method comprises:
receiving a first transaction for deploying a first contract, wherein the first transaction invokes a second contract, an incoming parameter for the second contract comprises a code identifier of a first code and a value of an immutable variable in the first code, the code identifier and the first code are pre-stored in the blockchain, the first code comprises a first function for initializing a contract, and the second contract comprises a call to the first function;
determining whether the second contract is a system contract before executing the first function based on the call in the second contract;
obtaining the first function in the first code based on the code identifier when determining that the second contract is a system contract; and
storing state data of the first contract in the blockchain by executing the first function, wherein the state data of the first contract comprises the code identifier and the value of the immutable variable.

2. The method according to claim 1, further comprising:
determining that the first transaction fails to be executed when determining that the second contract is not a system contract.

3. The method according to claim 1, wherein the incoming parameter for the second contract further comprises a first contract address of the first contract, and wherein the storing state data of the first contract in the blockchain by executing the first function comprises:
determining, by executing the first function, whether a state database comprises state data corresponding to the first contract address, and storing the state data of the first contract in the state database with the first contract address when the state database does not comprise the state data corresponding to the first contract address.

4. The method according to claim 1, wherein the state data of the first contract comprises a first field for storing the code identifier.

5. The method according to claim 1, wherein the state data of the first contract comprises a second field for storing the value of the immutable variable.

6. The method according to claim 1, further comprising:
receiving a second transaction for storing the first code, wherein the second transaction invokes the system contract, and wherein an incoming parameter for the system contract comprises the code identifier and the first code; and
storing the code identifier and the first code in state data of the system contract based on the second transaction.

7. The method according to claim 6, wherein the method further comprises:
receiving a third transaction for updating the first code, wherein the third transaction invokes the system contract, and the incoming parameter for the system contract comprises an updated first code; and
storing the updated first code in the state data of the system contract based on the third transaction.

8. The method according to claim 5, further comprising:
receiving a fourth transaction for invoking the first contract;
obtaining the code identifier and the value of the immutable variable from the state data of the first contract based on the fourth transaction;
reading the first code from the blockchain based on the code identifier; and
executing the first contract based on the first code and the value of the immutable variable.

9. The method according to claim 8, wherein the fourth transaction invokes the first function of the first contract, and wherein the executing the first contract based on the first code and the value of the immutable variable comprises:
replacing an immutable variable in the first function with a value of a first variable to obtain a third code; and
executing the third code.

10. A blockchain node, comprising:
at least one processor; and
one or more memories coupled to the at least one processor and storing programming instructions for execution by the at least one processor to perform operations comprising:
receiving a first transaction for deploying a first contract, wherein the first transaction invokes a second contract, an incoming parameter for the second contract comprises a code identifier of a first code and a value of an immutable variable in the first code, the code identifier and the first code are pre-stored in the blockchain, the first code comprises a first function for initializing a contract, and the second contract comprises a call to the first function;
determining whether the second contract is a system contract before executing the first function based on the call in the second contract;
obtaining the first function in the first code based on the code identifier when determining that the second contract is a system contract; and
storing state data of the first contract in the blockchain by executing the first function, wherein the state data of the first contract comprises the code identifier and the value of the immutable variable.

11. The blockchain node according to claim 10, further comprising:
determining that the first transaction fails to be executed when determining that the second contract is not a system contract.

12. The blockchain node according to claim 10, wherein the incoming parameter for the second contract further comprises a first contract address of the first contract, and wherein the storing state data of the first contract in the blockchain by executing the first function comprises:
determining, by executing the first function, whether a state database comprises state data corresponding to the first contract address, and storing the state data of the first contract in the state database with the first contract address when the state database does not comprise the state data corresponding to the first contract address.

13. The blockchain node according to claim 10, wherein the state data of the first contract comprises a first field for storing the code identifier.

14. The blockchain node according to claim 10, wherein the state data of the first contract comprises a second field for storing the value of the immutable variable.

15. The blockchain node according to claim 10, further comprising:
receiving a second transaction for storing the first code, wherein the second transaction invokes the system contract, and wherein an incoming parameter for the system contract comprises the code identifier and the first code; and
storing the code identifier and the first code in state data of the system contract based on the second transaction.

16. The blockchain node according to claim 15, wherein the method further comprises:
receiving a third transaction for updating the first code, wherein the third transaction invokes the system contract, and the incoming parameter for the system contract comprises an updated first code; and
storing the updated first code in the state data of the system contract based on the third transaction.

17. The blockchain node according to claim 14, further comprising:
receiving a fourth transaction for invoking the first contract;
obtaining the code identifier and the value of the immutable variable from the state data of the first contract based on the fourth transaction;
reading the first code from the blockchain based on the code identifier; and
executing the first contract based on the first code and the value of the immutable variable.

18. The blockchain node according to claim 17, wherein the fourth transaction invokes the first function of the first contract, and wherein the executing the first contract based on the first code and the value of the immutable variable comprises:
replacing an immutable variable in the first function with a value of a first variable to obtain a third code; and
executing the third code.

19. A non-transitory, computer-readable medium storing one or more instructions executable by at least one processor to perform operations comprising:
receiving a first transaction for deploying a first contract, wherein the first transaction invokes a second contract, an incoming parameter for the second contract comprises a code identifier of a first code and a value of an immutable variable in the first code, the code identifier and the first code are pre-stored in the blockchain, the first code comprises a first function for initializing a contract, and the second contract comprises a call to the first function;
determining whether the second contract is a system contract before executing the first function based on the call in the second contract;
obtaining the first function in the first code based on the code identifier when determining that the second contract is a system contract; and
storing state data of the first contract in the blockchain by executing the first function, wherein the state data of the first contract comprises the code identifier and the value of the immutable variable.

20. The non-transitory, computer-readable medium according to claim 19, further comprising:
determining that the first transaction fails to be executed when determining that the second contract is not a system contract.
